(19) United States
(12) Patent Application Publication
(10) Pub. No.: US 2007/0066207 A1
(43) Pub. Date: Mar. 22, 2007

(54) Vehicle roof mounted exterior air extraction unit

(76) Inventors: Michael Alexander Smith, Taumarunui (NZ); Carolyn Yndra Smith, Taumarunui (NZ)

Correspondence Address: MICHAEL SMITH AND ASSOCIATES LIMITED, RD ONGARUE STREAM ROAD, WAIMIHA, TAUMARUNUTI, KING COUNTRY, 3998, NZ

(21) Appl. No.: 11/507,977

(22) Filed: Aug. 23, 2006

Related U.S. Application Data
(60) Provisional application No. 60/714,208, filed on Sep. 6, 2005.

(51) Int. Cl. B60H 1/00

(52) U.S. Cl. 454/69

(57) ABSTRACT

A vehicle roof mounted exterior air extraction unit with an elevated profile to exclude moisture from entering the vehicle, incorporating a fan for removing hot air from inside the vehicle on hot days, powered by a photovoltaic solar cell activated by an infra-red signal when the vehicle is stationary, with the whole unit incorporated in a stylised low wind resistant shape that compliments modern vehicle design.

### BACKGROUND

Owners of motor vehicles obliged to park in sunny, hot conditions are faced with a choice between locking securely and facing oven like conditions on return or providing for some limited air throughput by leaving windows open and compromising the security of the vehicle and/or its contents.

Car manufacturers have not addressed this issue even though it is a continuing source of discomfort and a risk to occupants and possessions subject to the extreme temperatures that can be reached even in a short time in the peak of summer conditions.

By developing an extraction system powered by the very source of the problem (sun/solar) an air extractor mounted on the exterior of the vehicle allows cooler air from outside the vehicle to be drawn through the vehicle's existing ventilation ducting during the most oppressive period of the day. This can be done without compromising the security of the vehicle.

Previous designs submitted for this solution have failed to address the essential weatherproofing requirements of an equipment item that penetrates the roof of a motor vehicle. The design covered by this application seeks to overcome that inherent deficiency by elevating the functional components of the fan and solar power source so that the entire unit is able to resist the entry of moisture when the vehicle is in use.

### BRIEF SUMMARY

The Vehicle Roof Mounted Air Extraction Unit is an elevated exterior attachment for a motor vehicle that uses solar energy to power a roller fan that draws air from inside a parked vehicle through an access slot cut into the roof of the vehicle.

By positioning the functional elements of the design above and away from the vehicle roofline it is possible to overcome the problem of moisture entry into the vehicle interior.

### BRIEF DESCRIPTION OF THE DRAWINGS.

FIG. 1a shows the general location of the unit on the vehicle roof.

FIG. 1b shows proximity to the rear window.

FIG. 2 side elevation with section through unit showing the elevated positioning of the roller fan and solar panel and the mounting to vehicle roof with the downward directed and rearward facing exhaust vent.

FIG. 3 front elevation highlighting the spread top to accommodate the solar panel.

FIG. 4 rear elevation illustrating the exhaust vent and drainage hole.

FIG. 5 the plan view.

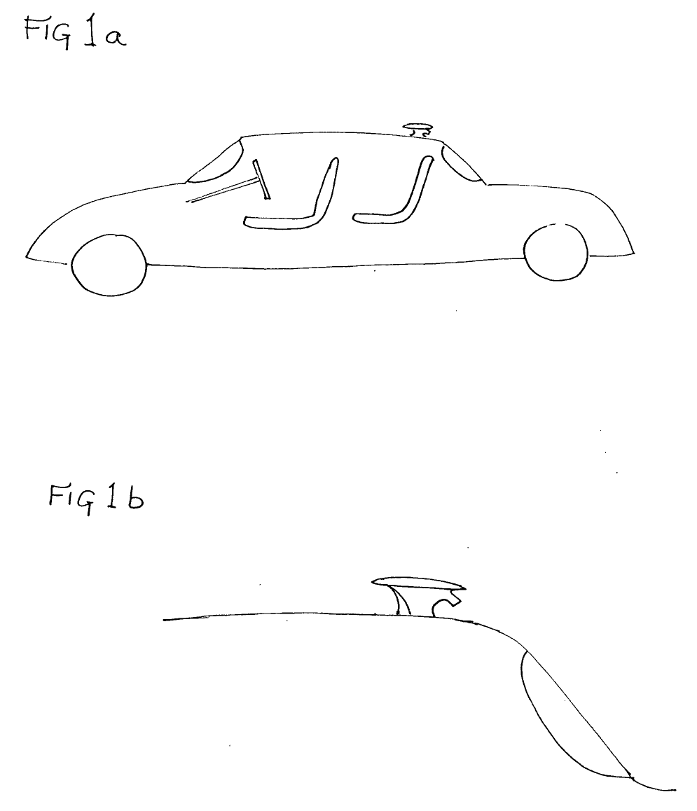

### DETAILED DESCRIPTION OF THE INVENTION

The essential ingredient of the Vehicle Roof Mounted Air Extraction Unit is an elevated design that fulfils all the functional requirement of an air extraction unit without compromising the essential weatherproof requirements of the vehicle.

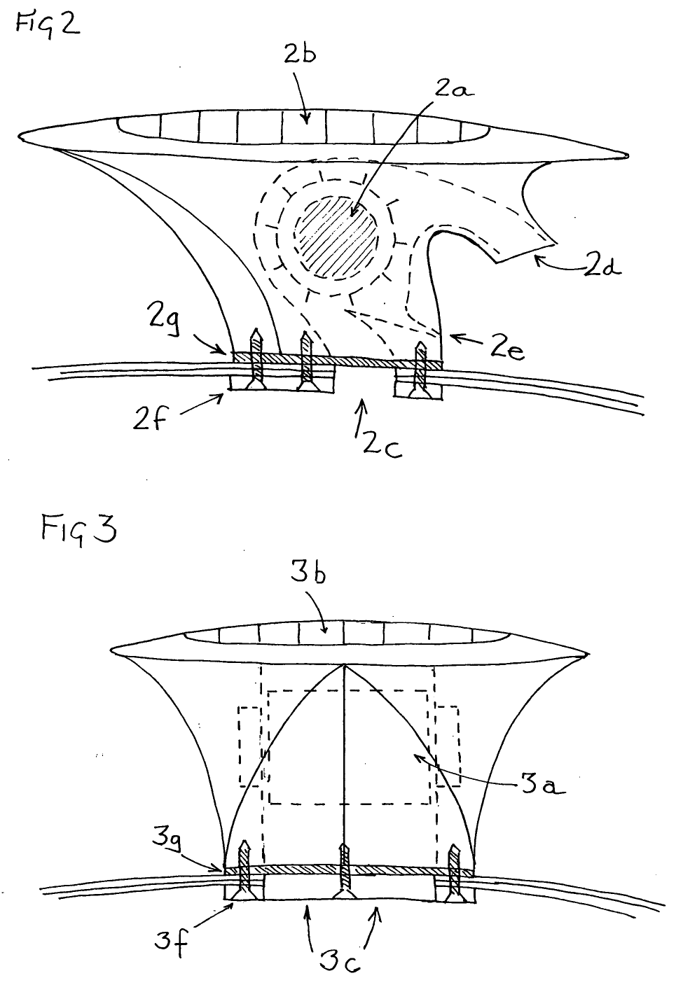

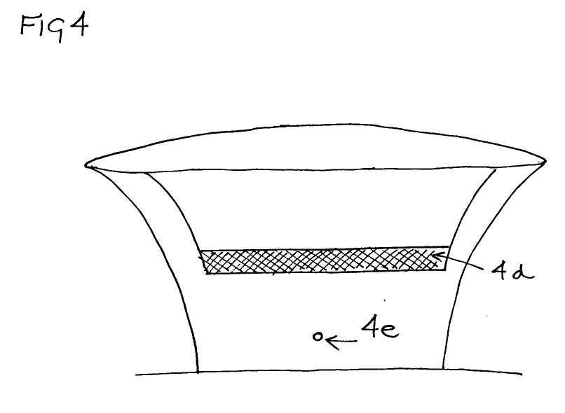

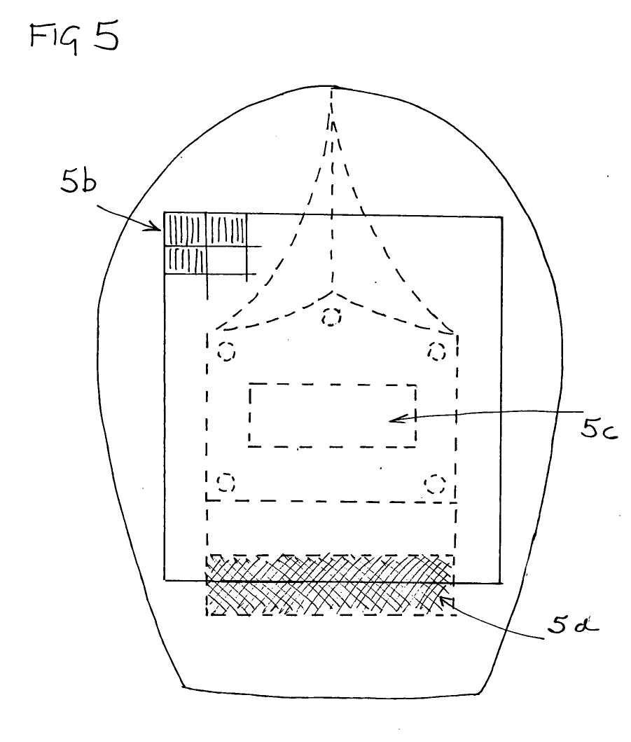

By incorporating a low drag shape that blends to modern vehicle design concepts the unit is able to combine the practical necessities of ventilation and enhance the presentation of the vehicles final appearance to make this a desirable accessory. (FIG. 2 side elevation FIG. 3 front elevation, FIG. 4 rear elevation and FIG. 5 plan view showing unit mounted on vehicle roof).

By elevating all the functional elements of the design away from the main body of the vehicle it is possible to provide a more secure and weathertight attachment to the vehicle roof. The downward and rearward facing exhaust vent is angled to eliminate unwanted water entry.

The roller fan motor (see FIGS. 2a and 3a) is direct solar powered (no storage battery) by a photovoltaic solar energy panel mounted on the top surface of the unit (see FIGS. 2b, 3b and 5b plan view ). This will ensure that the unit will function at its most efficient when the sun is striking directly on the vehicle and the need for the fan is at its most critical.

The Vehicle Roof Mounted Air Extraction Unit is installed at the rear of the roofline just ahead of the rear window. This ensures that air entering through the vehicles own ducting system is drawn across the full length of the interior space before entering the extraction unit through the access slot (see FIGS. 2c, 3c and 5c) and then discharged out the exhaust vent (see FIGS. 2d, 4d and 5d). Its aerodynamic shape and minimal size limits its impact on vehicle performance. A drainage channel is located immediately below the exhaust vent to expel any moisture entering the exhaust vent (see FIGS. 2e and 4e).

To install the Vehicle Roof Mounted Air Extraction Unit requires a small slot to be cut in the rear portion of roof and holes to be drilled for the mounting screws which in addition to securing the unit to the vehicle also attaches the interior vent trim panel to the main unit (see FIGS. 2f and 3f).

To adapt the unit to varying roof contours will be an important characteristic to gain widespread acceptance. This is done by supplying a selection of flexible mounting gaskets (see FIGS. 2g and 3g) of varying contours to achieve a secure mount and a watertight fit.

The unit will be offered in a range of colours to enable complementary matching to existing body colours.

The Vehicle Roof Mounted Air Extraction Unit is activated only when the vehicle is stationary and is brought into use using an infra-red signal of the same type as that used for activating the vehicle remote locking system with the sender unit located on the drivers key chain.

The Vehicle Roof Mounted Air Extraction Unit can either be supplied as an accessory to be fitted after the purchase of the vehicle or incorporated into the vehicles specification by the vehicle manufacturer at the time of assembly. In this instance the infra-red signal can be common to both the remote locking system and fan activation.

It will be appreciated that the invention broadly consists in the parts, elements and features described in this specification, and is deemed to include any equivalents known in the art which if substituted for the described integers, would not materially alter the substance of the invention.

1. A Vehicle roof mounted exterior air extraction unit of an elevated profile to ensure superior weatherproofing that is located on the rearward section of a motor vehicle roof and is complementary in styling to modern automotive profiles
and that uses an electrically powered roller fan to remove warm air from inside the passenger space, when the vehicle is stationary, through a slot cut into the roof to which the unit is securely mounted, drawing air through the vehicles existing venting ducts,
and combining in its design criteria a low air resistant shape with a rearward and downward facing exhaust vent that will not permit the entry of moisture into the vehicles interior.

2. That the roof mounted air extraction unit as claimed in claim 1 be supplied with electrical energy from the sun through the use of a photovoltaic solar panel located on the flat top of the unit which directly operates the fan so that at times of highest direct sun levels and consequently most extreme interior temperatures the fan will operate at maximum efficiency to fulfil its ventilation function.

3. That the air extraction unit as claimed in claim 1 may be installed either after initial purchase of the vehicle as an accessory or incorporated into the manufacture of the vehicle at the time of its construction.
